(19) United States
(12) Patent Application Publication
(10) Pub. No.: US 2011/0307255 A1
(43) Pub. Date: Dec. 15, 2011

(54) System and Method for Conversion of Speech to Displayed Media Data

(75) Inventors: William H. Frazier, Dallas, TX (US); William Greg Peterson, Waco, TX (US)

(73) Assignee: Logoscope LLC, Dallas, TX (US)

(21) Appl. No.: 13/157,458

(22) Filed: Jun. 10, 2011

Related U.S. Application Data
(60) Provisional application No. 61/353,275, filed on Jun. 10, 2010.

(51) Int. Cl. G10L 15/26

(52) U.S. Cl. 704/235; 704/E15.045

(57) ABSTRACT

A method for instantaneous and real-time conversion of sound into media data and with the ability to project, print, copy, or manipulate such media data. The invention relates to a method for converting speech to a text string, recognizing the text string, and then displaying the media data that corresponds with the text string.

Specifically, the invention contemplates a method where the program converts a spoken word to a text string, compares that text string to an image library containing media data that is associated with the text string, and if the text string matches a text string in the library, projects the media data that corresponds with the text string.

### CLAIMING PRIORITY ON A PROVISIONAL

This application claims priority under 35 U.S.C. §119 of provisional application Ser. No. 61/353,275 filed Jun. 10, 2010 entitled: System and Method for Conversion of Speech to Displayed Media Data.

### TECHNICAL FIELD OF THE INVENTION

This invention relates in general to software and, more particularly, to a software method for instantaneous and real-time conversion of sound into media data with the ability to project, print, copy, or manipulate such media data. Specifically, the invention relates to a method for converting speech to a text string, recognizing the text string, and then displaying the media data that corresponds with the text string.

### BACKGROUND OF THE INVENTION

One object of the invention is to provide a real-time method for displaying media data that corresponds with a spoken word or phrase. This allows a person to speak a word and associate it with an image. This is particularly useful to teach an individual a new language. Moreover, the invention contemplates a method that is helpful when teaching individuals with learning disabilities, such as autism. Additionally, the method can be used as a mechanism for individuals that speak different languages to communicate effectively through visual recognition.

Another object of the invention is to provide a real-time method for displaying media data that corresponds with a presentation or story. This allows a person to make a customized presentation or read a story without having to manually update the progress of the presentation or story. This further allows a person to make a presentation or read a story without having to manually update the displayed media data.

### SUMMARY OF THE INVENTION

The present invention provides a system to implement methods for the instantaneous and real-time conversion of sound to text and then to displayed media data. Moreover, the invention has the simultaneous ability to project, print, copy, or manipulate such media data.

To achieve the objectives of the present invention, an identification station is required. In one embodiment, the identification station consists of a personal computer and commercially available speech-to-text recognition hardware and software, such as Nuance's Dragon Naturally Speaking (“Dragon”) to convert sounds to text strings. The invention then reads the converted text string and determines whether it matches a text to string in a media library. If the text string is a match, then the associated media data is displayed on a monitor or other graphical user interface (“GUI”).

### BRIEF DESCRIPTION OF THE DRAWINGS

To provide a more complete understanding of the present invention and features and advantages thereof, reference is made to the following description, taken in conjunction with the accompanying figures, where like reference numerals represent like parts, in which:

FIG. 1 shows a block diagram of a personal computer that may be used to implement the method of the present invention;

FIG. 2 is a flow diagram illustrating the media data library management process flow using elements contained in a personal computer in accordance with one embodiment of the invention disclosed herein;

FIG. 3 is a flow diagram illustrating the media data library management process flow using elements contained in a personal computer in accordance with one embodiment of the invention disclosed;

FIG. 4 is a flow diagram illustrating the build projects process flow using elements contained in a personal computer in accordance with one embodiment of the invention disclosed herein;

FIG. 5 is a flow diagram illustrating the system setup management process flow using elements contained in a personal computer in accordance with one embodiment of the invention disclosed herein; and

FIG. 6 is a flow diagram illustrating the main menu process flow using elements contained in a personal computer in accordance with one embodiment of the invention disclosed herein.

### DETAILED DESCRIPTION OF THE INVENTION

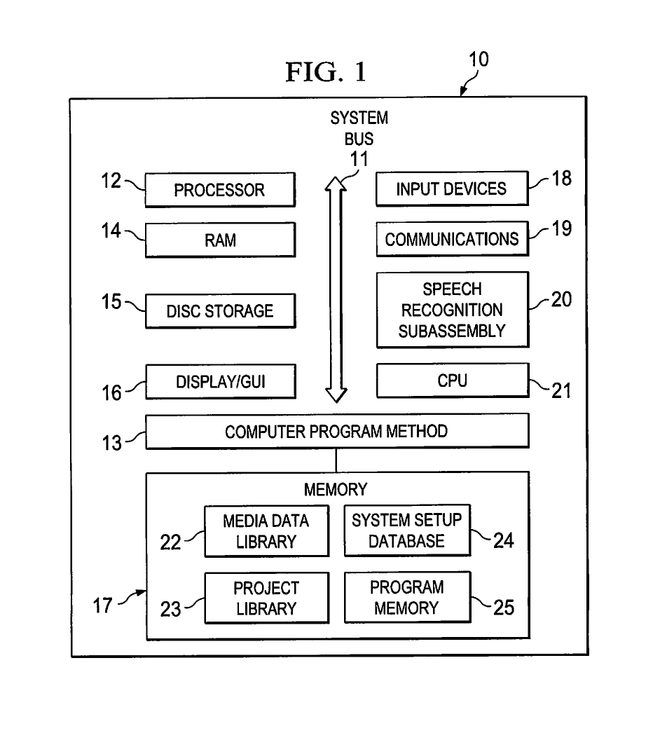

FIG. 1 shows a block diagram describing a physical structure in which the methods according to the invention can be implemented. Specifically, this diagram describes the realization of the invention using a personal computer. But, in practice, the invention may be implemented through a wide variety of means in both hardware and software. For example, the methods according to the invention may be implemented using a personal computer running a speech recognition subassembly, such as Dragon. The invention may also be implemented through a network or the Internet and/or be implemented with PDAs, such as Iphones, Blackberrys, and other mobile computing devices. The invention may further be implemented using several computers connected via a computer network.

To achieve the objectives of the present invention, the invention may be implemented with a personal computer. FIG. 1 depicts a representative computer on which the invention may be performed. The computer 10 has a central processing unit (“CPU”) 21, processor 12, random access or other volatile memory 14, disc storage 15, a display/graphical user interface (GUI) 16, input devices (mouse, keyboard, and the like) 18, an appropriate communications device 19 for the interfacing the computer to a computer network. Such components may be connected by a system bus 11 and various PCI buses as generally known in the art or by other means as required for implementation.

The computer has memory storage 17, which includes the media data library 22, the project library 23, the system setup database 24, and the program memory 25. The program memory 25 consists of two separate columns: the project column and the media data column. When the user chooses to run the methods described herein, the program utilizes random access memory 14 to load information from the media data library 22 and project library 23 into program memory.

Random access memory 14 supports the computer software 13 that provides the methodological functionality of the present invention. In one embodiment, the operating system preferably is a single-process operating environment running multiple threads at a single privilege level. The host system is a conventional computer having a processor and running an operating system. The host system supports a GUI 16.

The personal computer according to the present invention is equipped to provide data input through speech recognition. To that end, the computer includes a speech recognition subassembly 20. The speech recognition subassembly includes a microphone; an analog-to-digital converter for converting data supplied via the microphone input; a CPU; processing means for processing data converted by the analog-to-digital converter; memory means for data and program storage, such as a ROM memory for program storage and a RAM memory for data storage; a power supply; and an interfacing means, such as a RS 232 connection. Speech recognition technology has reached the point where affordable commercial speech recognition products are available for desktop systems. One such example is Dragon, a commercially available speech to text software.

Those of ordinary skill in the art will appreciate that the hardware depicted in FIG. 1 may vary. For example, other peripheral devices may be used in addition to or in place of the hardware discussed in FIG. 1. The depicted example is not meant to imply architectural limitations with respect to the present invention and may be configured to operate in various network and single client station formats.

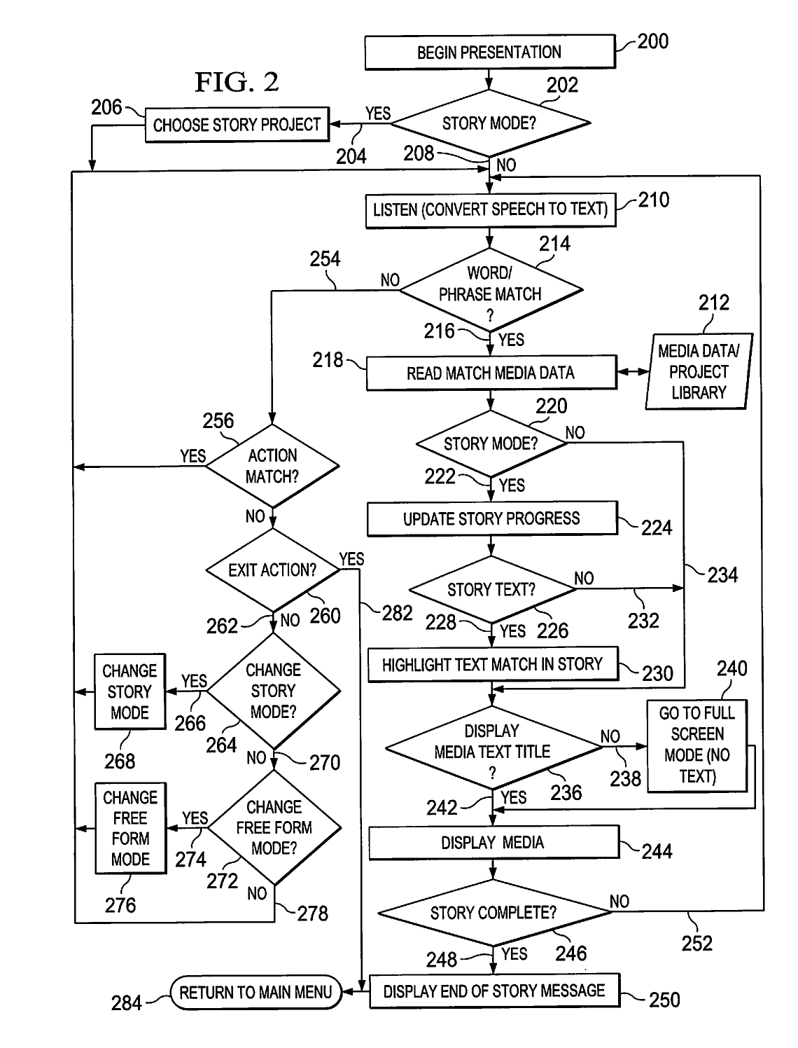

FIG. 2 is a flow diagram illustrating the presentation method of the invention using elements contained in a personal computer. In practice, the presentation method can be implemented through a variety of software and hardware means such as a personal computer, a server, an Iphone, or other personal digital devices as are known in the art.

FIG. 2 depicts a method by which a user speaks a word and corresponding media data is displayed on a computer monitor or other GUI. A user might find this method helpful to, among other things, learn a language, communicate with others who speak a different language, or teach communication techniques to children with autism.

For example, consider that a user wants to learn a new language. Specifically, the user wants to learn to associate the sound “pig” with a picture of a pig. The user starts the program. The user chooses to run the presentation method. When prompted, the user chooses to run the program in “free form” mode. The user speaks the word “pig” into the microphone. The speech recognizer recognizes this word and converts the speech to a text string. The program compares the text string to hit words in the media data library. If a match is found, then the media data, which corresponds with the matched hit word, is displayed on the screen, resulting in an image of a pig being displayed on a computer monitor, GUI or other desired display device. If the program waits for the user to speak another word, which can be converted to a text string by the speech recognizer.

In one embodiment, the user chooses to begin the presentation method 200. The user then has the option to choose whether to run the presentation method in story mode or free form mode 202.

In this embodiment, the user selects story mode 204. The user then selects a pre-loaded story project 206, which is stored in the project library. The program reads the story project data from the project library and loads the hit words from the selected story project into the project column of program memory. The hit words are loaded in the project column in 1-n order, the first entry being the first hit word in the story and the n^{th} entry being the last hit word in the story.

The system also reads the data from the media data library and loads the hit words from the media data library into the media data column of program memory. The order in which the media data library hit words are loaded is not important.

The method then enters a loop where it waits for the speech recognizer to recognize a sound input into a microphone 210. When the speech recognizer recognizes a sound, it converts the inputted speech to a text string using methods commonly known in the art, and the system exits the loop 210.

The presentation method then accepts this text string from the buffer and determines whether the converted text string matches a text string in the project column of program memory 214. The program makes this determination using a “for” loop. The n^{th} time the system enters the for loop, it determines whether the text string matches the ^{nth} hit word in the project column using methods commonly known in the art. For example, the first time the program retrieves a text string from the buffer, it determines whether that text string matches the first entry in the project column.

If the text string is a match 216, then the presentation method reads the media data that corresponds to the matching hit word in the project library 212, 218.

In this embodiment, the presentation method started in story mode. However, the user can choose to leave story mode and switch to free form mode. Therefore, the presentation method determines whether the presentation method is running in story mode 220. The program makes this determination by reading a variable in memory that keeps track of the mode the user is in. If the presentation method is still operating in story mode 222, then the project story is updated from the project library to reflect the progress of the project story 224.

The presentation method then reads the data in the project library corresponding with the text string or hit word to determine whether the user indicated that the story text should be displayed 226. If the user requested that the story text should not be displayed 232, then the presentation method looks to the project library to determine whether the user inputted information to indicate that the media text title should be displayed 236. If the user requested that the media text title be displayed 242, then the media data and the media data text are displayed on the screen 224. If the user requested that the media text title not be displayed 238, then the presentation method switches to full screen mode 240. The media data is then retrieved from the project library, and the media data without the media text title is displayed on the screen 244.

The presentation method then reads the data in the project library corresponding with the text string or hit word to determine whether the user indicated that the story text should be displayed 2323, then the presentation method looks to the project library to determine whether the user inputted information to indicate that the media text title should be displayed 236. If the user requested that the media text title be displayed 242, then the media data and the media data text are displayed on the screen 244. If the user requested that the media text title not be displayed 238, then the presentation method switches to full screen mode 240. The media data is then retrieved from the project library, and the media data without the media text title is displayed on the screen 244.

At step 226, if the presentation method determines that the user requested that the story text be displayed 228, then the story text is highlighted on the screen to match the progress of the story 230. The presentation method then looks to the project library to determine whether the user inputted information to indicate that the media text title should be displayed 236. If the user requested that the media text title be displayed 242, then the media data and the media data text are displayed on the screen 244. If the user requested that the media text title not be displayed 238, then the presentation method switches to full screen mode 240. The media data is then retrieved from the project library, and the media data without the media text title is displayed on the screen 244.

The presentation method then determines whether the story is complete 246. Specifically, the program determines whether the text string in the buffer matches the n^{th} and final hit word in the project column. If the text string does not match the n^{th} hit word, then the story is not complete 252.

The method then re-enters the loop where it waits for the speech recognizer to recognize a sound input into a microphone 210. The method continues to operate from step 210.

If the presentation method determines that the story is complete because the text string in the buffer matches the n^{th} and final hit word in the project column 248, then an end of story message is displayed 250, and the presentation method terminates 284. The user is returned to the main menu 284.

Alternatively, in this embodiment, at step 220, if the user has switched from story mode to free form mode 234, then the presentation method reads data in the media data library to determine whether the user inputted that media text title should be displayed 236 for the corresponding text string in the media data library. If the user requested that the media text title be displayed 242, then the media data and the media text title not be displayed 238, then the presentation method switches to full screen mode 240. The media data is retrieved from the media data library, and the media data without the media text title is displayed on the screen 244.

The presentation method then determines whether the project story is complete 246. Since the user switched to free form 276, the presentation method defaults to conclude that the story is not complete 252. The presentation method then waits for a sound to be input into the microphone 210. The method continues to run from step 210.

Regardless of what mode the program is running in, at step 214, if the text string does not match a hit word in the word/phrase match loop 254, then the presentation method enters an action match loop. Therefore, the program looks to the action phrases to determine whether the text string matches an action phrase 256.

If the text string is not an action match for exit action (262), then the presentation method determines whether the text string matches the action hit phrase “change to story mode” 264. In order for the presentation method to have the ability to “change to story mode,” the user had to initially select to start the presentation method in story mode 204. Hence, first the presentation method determines whether the user initially selected to start the presentation method in story mode at step 204. The program makes this determination by reading a variable in memory that keeps track of the mode the user is in. If the user initially selected story mode 204, then if the text string is an action match for “change to story mode” 266, the presentation method switches to story mode 268. The user selects a story project, and the program reads the data from the story project and loads the hit words from the story project in project library into a project column in program memory. The program also reads the data from the media data library and loads the hit words from the media data library into a media data column in program memory. The program continues to run from step 210. But, if the user did not initially select story mode 208, then the presentation method defaults to the conclusion that the text string does not match “change to story mode” 270.

Next, if the text string is not an action match for “change to story mode” 266, then the presentation method determines whether the text string matches the action hit phrase “change to free form” 272. If the text string matches the hit phrase “change to free form” 274, then the presentation method switches to free form mode 276. The program reads the data from the media data library and loads the hit words from the media data library into a media data column in program memory. The program continues to run from step 210. If the text string is not an action match for “change to free form” 278, then the presentation method continues to operate in the same mode it is currently in from step 210.

In an alternative embodiment, the user chooses to begin the presentation 200. The user then has the option to choose story mode or free form mode 202. In this embodiment, the user selects free form mode 208. The program reads the data from the media data library and loads the hit words from the media data library into the media data column of program memory. The order in which the media data library hit words are loaded is not important.

The method then enters a loop where it waits for the speech recognizer to recognize a sound input into a microphone 210. When the speech recognizer recognizes a sound, it converts the inputted speech to a text string using methods commonly known in the art, and the system exits the loop 210.

The presentation method then accepts this text string from the buffer and determines whether the text string matches a hit word in the media data column of program memory 214. The system determines whether the text string matches a hit word in the media data column using the word/phrase match loop.

If the text string is a match 216, then the presentation method reads the media data that corresponds to the matching hit word in the media data library 212, 218.

Because the program started running in free form mode, the variable in memory, which tracks which mode the program is running in, will be set to free form mode. Therefore, the presentation method determines that the presentation method is not running in story mode 220, 235. Importantly, if the presentation method originates in free form mode, then it can never be switched to story mode.

The presentation method looks to data in the media data library that corresponds with the hit word in the media data column in program memory to determine whether the user inputted that the media text title should be displayed 236. If the user requested that the media text title be displayed 242, then the media data and the media text title are retrieved from the media data library, and the media data and the media text title are displayed on the screen 244. If the user requested that the media text title not be displayed 238, then the presentation method switches to full screen mode 240. The media data is retrieved from the media data library, and the media data without the media text title is displayed on the screen 244.

The presentation method then determines whether the story is complete 246. In this embodiment, the presentation method started in free form mode 208. Therefore, the presentation method determines that the presentation method is not operating in story mode by reading the variable in memory that tracks which mode the program is running in, and therefore that the story is not complete 252. The program continues to run from step 210.

At step 214, if the text string does not match a hit word in the word/phrase match loop 254, then the presentation method enters an action match loop 256. The action phrases are hard coded into the program when it is compiled. Therefore, the program looks to the action phrases to determine whether the text string matches an action phrase 256.

If the text string matches the action hit phrase “exit action” 260, 282, then the presentation method terminates 284. The user is returned to the main menu 284.

Next, if the text string is not an action match for exit action 262, then the presentation method determines whether the text string matches the action hit phrase “change to story mode” 264. In order for the presentation method to have the ability to “change to story mode,” the user had to initially select to start the presentation method in story mode 204. Because in this embodiment, the user selected to start the program in free form mode 208, the presentation concludes that the text string does not match “change to story mode” 270.

Next, because the text string is not an action match for “change to story mode” 266, the presentation method determines whether the text string matches the action hit phrase “change to free form” 272. If the text string matches the hit phrase “change to free form” 274, then the presentation method switches to free form mode 276. The program reads the data from the media data library and loads the hit words from the media data library into a media data column in program memory. The program continues to run from step 210. If the text string is not an action such as “change to free form” 278, then the presentation method continues to operate in the same mode it is currently in from step 210.

The following is a real-world example of how a user may use the invention described herein. Consider that Mary wants to learn English. Specifically, Mary wants to teach her brain to associate spoken English words with recognizable images. Mary turns on her computer and loads the invention. Mary is presented with a main menu. Mary chooses to run the presentation process. The program prompts Mary to choose to run the program in either story mode or free form mode. In the example, Mary decides to run the program in free form mode. At this point, the program waits for Mary to speak a word. Mary speaks “dog” into the microphone. The program converts Mary's speech to a text string. The program then determines whether that text string matches a hit word entry in the media data library. If the text string matches a hit word in the media data library, then the program projects the media data that corresponds with the text string “dog” on the monitor or other GUI. Specifically, in this example, the program displays a picture of a dog on the monitor or other GUI. The program then waits for Mary to speak a different word. If the program is not able to convert the word Mary speaks to a text string because it does not recognize the word or alternatively if the program converts the word to a text string but the text string does not match a hit word in the media data library, then the program waits for Mary to speak another word.

If at any time Mary decides she is done running the presentation process, she can speak “exit” into the microphone. The program will then return Mary to the main menu.

Consider another real-world example of how Mary may use the invention described herein. Presume that Mary wants to give a presentation about her most recent vacation. Mary turns on her computer and loads the program. Mary is presented with a main menu. Mary chooses to run the presentation process. The program prompts Mary to choose to run the program in either story mode or free form mode. In this example, Mary wants to tell a story about her recent vacation using a preloaded story project. Specifically, Mary wants to tell the following story entitled “Vacation”: “I drove my car to the beach last week and saw dolphins.” Mary wants a picture of her car to display on the monitor when she says “car.” She wants a picture of a beach in Florida to display on the monitor when she says “beach,” and she wants a picture of dolphins to display when she says “dolphin.” Mary has already entered this information into the “Vacation” project. Therefore, Mary chooses to run the program in story mode and selects the “Vacation” project.

The program loads the “Vacation” project. At this point, the program waits for Mary to speak a word. Mary speaks “I drove my car to the beach last week and saw dolphins” into the microphone. The program converts Mary's speech to text strings. When the program converts “car” to a text string and matches it with a hit word in the project library, the picture of a car is displayed on the monitor. Similarly, when the program converts “beach” to a text string and matches it with a hit word in the project library, the picture of a Florida beach is displayed on the monitor. Further, when the program converts “dolphins” to a text string and matches it with a hit word in the project library, a picture of dolphins is displayed on the monitor. After Mary finishes her story, the program determines that the story is complete and displays an end of story message. Mary is then returned to the main menu.

If at any time during her story, Mary wishes to switch to free form mode, she must speak “free form” into the microphone. The program will then switch to that mode. If she wants to exit the presentation process, she must speak “exit” into the microphone. She will be returned to the main menu.

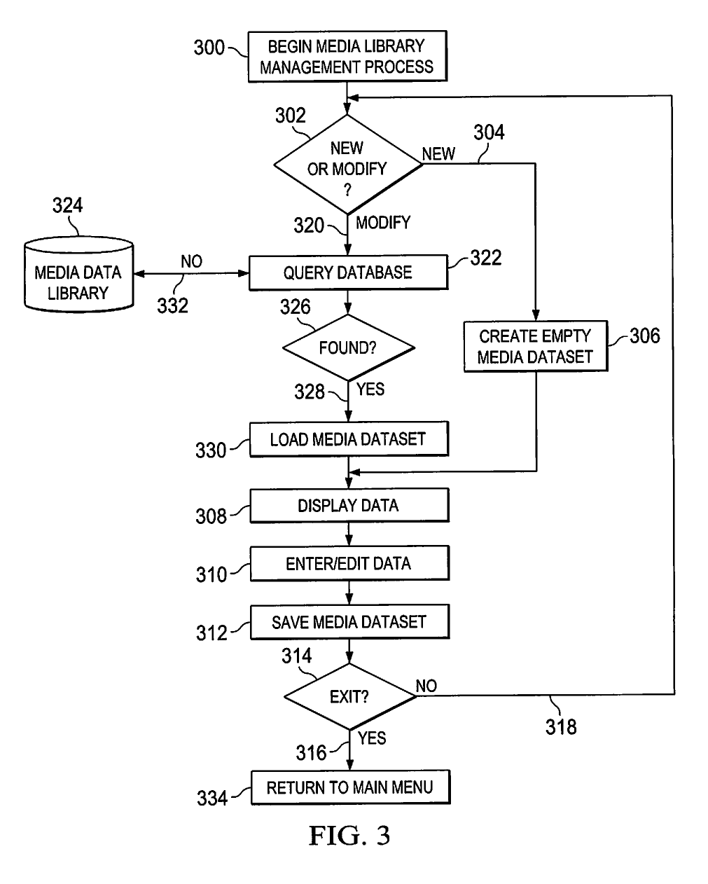

FIG. 3 is a flow diagram illustrating the media data library management process flow of the invention using elements contained in a personal computer. In practice, the media data library management process flow can be implemented through a variety of software and hardware means.

FIG. 3 depicts a method by which the user can set-up, create, and build the media data library. Specifically, FIG. 3 illustrates a method by which the user can add pictures and other media data to the media data library or edit or delete the same. This method gives the user the ability to customize the information in the media data library so that this customized information can be displayed when the user speaks a word that matches the media data's corresponding hit word.

In one embodiment, the user chooses to begin the media data library management process 300. The user then has the option to choose whether to create a new entry in the media data library or whether to modify an existing entry 302.

The user then enters data into the fields of the dataset 210. For example, the user may input data for, among other fields, the filename, description, hit word/phrase, category, title, display title, or media type. The user then saves the media dataset 312.

The user then decides whether to exit the media data library management process 314. If the user chooses to exit 316, then the program returns to the main menu 334. If the user does not choose to exit 318, then the user must select whether to create a new media data set or modify an existing dataset 302.

In an alternative embodiment, the user chooses to begin the media data library management process 300. The user then has the option to choose whether to create a new entry in the media data library or whether to modify an existing entry 302.

In this embodiment, the user chooses to modify an existing entry in the media data library 320. The user enters the data it wishes to find, and the program queries the media data library 322, 324. The program looks to the media data library to determine whether the search query matches an entry in the media data library 326. If the program determines the word is a match 328, then the program loads the media datasets existing in the media data library that match the search term 330.

Each matching dataset is displayed on the screen 308. The user then selects the media dataset it wishes to modify and enters data into blank fields or edits data in populated fields 310. For example, the user may input new data for or edit existing data for, among other fields, the filename, description, hit word/phrase, category, title, display title, or media type. The user then saves the media dataset 312.

The user must decide whether it would like to exit the media data library management process 314. If the user chooses to exit 316, then the program returns to the main menu 334. If the user does not choose to exit 318, then the user must decide whether he or she would like to create a new media data set or modify an existing dataset 302.

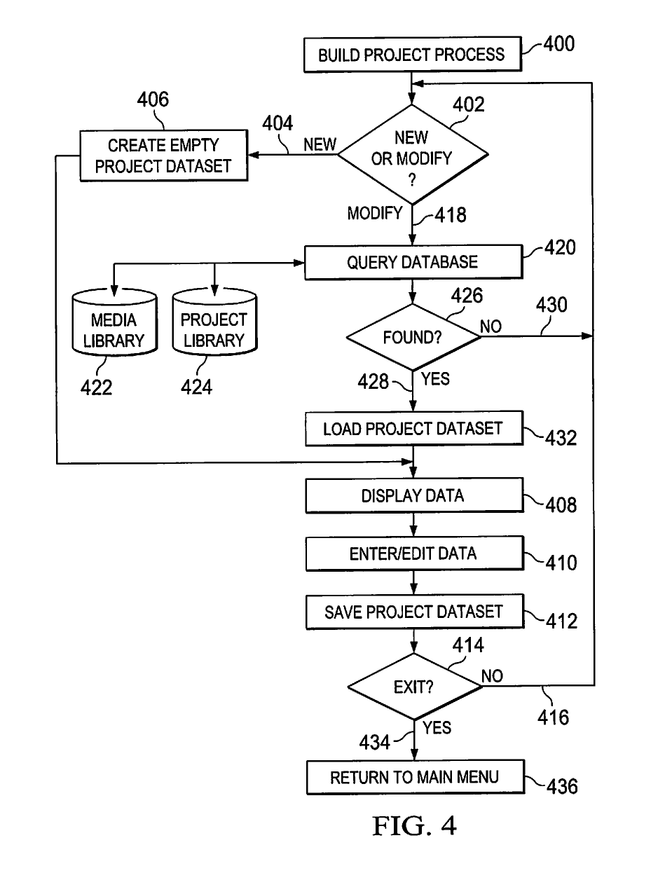

FIG. 4 is a flow diagram illustrating the build projects process of the invention using elements contained in a personal computer. In practice, the build projects process flow can be implemented through a variety of software and hardware means.

FIG. 4 depicts a method by which the user can set-up, create, and build the project library. Specifically, FIG. 4 illustrates a method by which the user can add pictures and other media data to the project library to create a project story or edit or delete the same. Importantly, media data can only be added to the project library if it exists first in the media data library. This method gives the user the ability to create customized story presentations. For example, if a user wants to create a presentation using pictures from his vacation, he would choose to build a story project in the project library. The user would load the pictures or media data he wants to be displayed and enter the corresponding identification information for each. The user would then arrange the pictures or media data in the order in which he wants them to be displayed during the presentation.

In one embodiment, the user chooses to begin the build projects process 400. The user then has the option to choose whether to create a new entry in the project library or whether to modify an existing entry 420. Importantly, the user cannot create a new project dataset unless the user will reference something that already exists in the media data library.

In this embodiment, the user chooses to create a new entry in the project library 404. The program creates an empty project dataset for the project library database 406. The data relating to each field in the project dataset is displayed on the screen 408. Because the user initially selected to create a new project dataset 404, the fields in the dataset will be blank.

The user then enters data into the fields of the dataset 410. For example, the user may input data for, among other fields, the project master, project name, description, project detail, override media flag, description, hit word/phrase, sequence number, media library item, title, display title, or story text. The user then saves the media dataset 412.

In an alternative embodiment, the user chooses to begin the build projects process 400. The user then has the option to choose whether to create a new entry in the project library or whether to modify an existing entry 402.

In this embodiment, the user chooses to modify an existing entry in the project library 418. The user enters the data it wishes to find, and the program queries the media data library and the project library 420, 422, 424. The program looks to the media data library and the project library 422, 424 to determine whether the search query matches an entry in the media data library or the project library 426. If the program determines the word is a match 428, then the program loads the datasets that match the search term 432. If more than one dataset is displayed, the user must select one dataset.

The data relating to each field in the project dataset is displayed on the screen 408. The user then enters new data into the fields or modifies existing data in the fields of the dataset 410. For example, the user may input new data or modify data for, among other fields, the project master, project name, description, project detail, override media flat, description, hit word/phrase, sequence number, media library item, title, display title, or story text. The user then saves the project dataset 412.

The program determines whether to exit the build projects process 414. If the user chooses to exit 434, then the program returns to the main menu 436. If the user does not choose to exit 416, then the user determines whether he or she would like to create a new project dataset or modify an existing dataset 402.

At step 426, if the search query does not match anything in the media data library or the project library 430, then the user determines whether to create a new project dataset or modify an existing dataset 402.

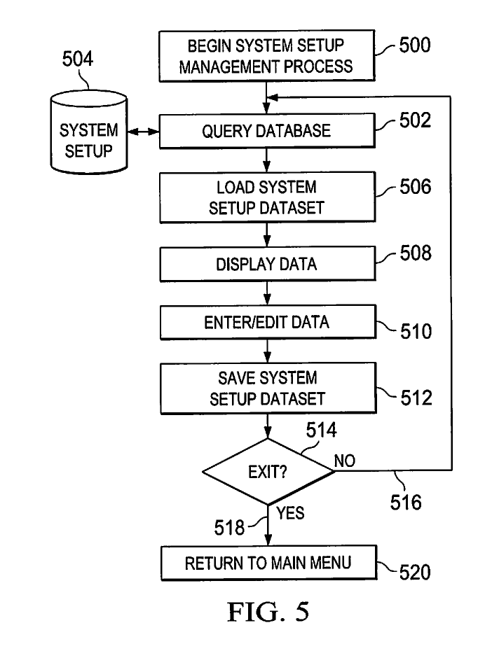

FIG. 5 is a flow diagram illustrating the system setup management process flow of the invention using elements contained in a personal computer. In practice, the system setup process flow can be implemented through a variety of software and hardware means. As a preliminary matter, system setup information is preloaded, but this process gives the user the opportunity to override this information.

In one embodiment, the user chooses to begin the system setup management process 500. The user then queries the system setup database to locate the information to override 502, 504. The program loads the corresponding system setup data 506.

The data is displayed on the screen 508. The user then modifies existing data in the fields of the dataset to override the preloaded data entries 510. For example, the user may modify data for, among other fields, the company name, the address, city, state, zip code, phone number, language, registration code, maximum image size, maximum audio length, maximum hit list, TTS engine, or VR engine. The user then saves the system setup dataset 512.

The user determines whether it would like to exit the system setup management process 514. If the user chooses to exit 518, then the program returns to the main menu 520. If the user does not choose to exit 516, then the user enters a search term to query the system setup database 502.

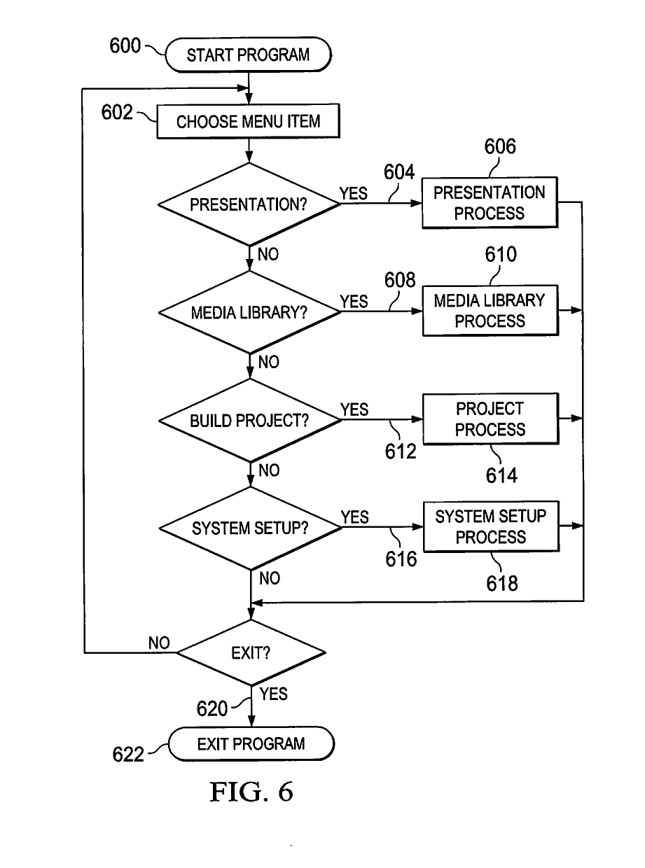

FIG. 6 is a flow diagram illustrating the process flow for the main menu process flow of the invention using elements contained in a personal computer. In practice, the main menu process flow can be implemented through a variety of software and hardware means, such as a personal computer, a server, an Iphone, a blackberry or other personal digital devices as are known in the art.

FIG. 6 depicts a method by which the user navigates through the methods of the invention. For example, if the user wants to give a presentation, then he selects presentation method from the main menu. The invention then runs the presentation method, and the user is able to give his presentation.

In one embodiment, the user starts to run the invention on a personal computer 600. The user is presented with a menu of several options, including Presentation, Media Data Library, Build Projects, System Setup, and Exit 602. The user selects a menu option 602.

If the user selects Presentation 604, then the program begins to run the presentation method 606. If the user selects Media Data Library 608, then the program begins to run the media data library management process 610. If the user selects Build Projects 612, then the program begins to run the build projects process 614. If the user selects System Setup 616, then the program begins to run the system setup management process 618. If the user selects Exit 620, then computer terminates the program 622.

Although the present invention has been described in detail with reference to particular embodiments, it should be understood that various other changes, substitutions, and alterations may be made hereto without departing from the spirit and scope of the present invention. The illustrated network architecture of FIG. 1 has only been offered for purposes of example and teaching. Suitable alternatives and substitutions are envisioned and contemplated by the present invention, with such alternatives and substitutions being clearly within the broad scope of communication system 10. For example, use of a local area network (LAN) for the outlined communications could be easily replaced by a virtual private network (VPN), a metropolitan area network (MAN), a wide area network (WAN), a wireless local area network (WLAN), or any other element that facilitates data propagation.

In addition, some of the steps illustrated in the preceding Figures may be changed or deleted where appropriate and additional steps may be added to the process flows. These changes may be based on specific learning architectures or particular interfacing arrangements and configurations of associated elements and do not depart from the scope of the teachings of the present invention. It is important to recognize that the Figures illustrate just one of myriad of potential implementations of the invention disclosed herein. Numerous other changes, substitutions, variations, alterations, and modifications may be ascertained to one skilled in the art, and it is intended that the present invention encompass all such changes, variations, alterations, and modifications as falling within the spirit and scope of the appended claims.

What is claimed is:

1. A method for a computer system that includes a processor and a memory operating in an electronic environment, comprising:
receiving a sound input from a user;
converting the sound input into a text string;
associating a hit word with a media data stored in a data library;
comparing the text string with at least one hit word associated with the media data stored in the data library; and,
presenting the associated media data.

2. The method of claim 1 wherein the associated media data is only presented if the text string and hit word match.

3. The method of claim 1 wherein a speech recognizer recognizes the sound input and converts the sound input into a text string.

4. The method of claim 1 wherein the media data library is generated by the user.

5. The method of claim 1 further comprising:
displaying a media text title.

6. The method of claim 1 wherein the media data is an image.

7. The method of claim 1 wherein the media data is a sound.

8. The method of claim 1 wherein the media data is presented by a display.

9. The method of claim 1 wherein the media data is presented by a soundspeaker.

10. The method of claim 1 wherein the media data is presented in a free-form mode.

11. The method of claim 1 wherein the media data is presented in a story mode.

13. The method of claim 1 wherein the media data is stored in a media data library.

14. The method of claim 1 wherein the media data is stored in a project library.

15. A computer program product for a computer system including a processor and a memory including a plurality of media data, comprising:
code directs the processor to receive a sound input from a user;
code directs the processor to convert the sound input into a text string;
code directs the processor to associate a hit word with a media data stored in a data library;
code directs the processor to compare the text string with at least one hit word associated with the media data stored in the data library; and,
code directs the processor to present the associated media data.

16. The computer program product of claim 15 wherein code directs the processor to present the associated media data if the text string and hit word match.

17. The computer program product of claim 15 wherein code directs the processor to instruct a speech recognizer to recognize the sound input and convert the sound input into a text string.

18. The computer program product of claim 15 wherein code directs the processor to display a media text title.

19. The computer program product of claim 15 wherein code directs the processor to present the media data in a free-form mode.

20. The computer program product of claim 15 wherein code directs the processor to present the media data in a story mode.
